(19) United States
(12) Patent Application Publication
(10) Pub. No.: US 2018/0298858 A1
(43) Pub. Date: Oct. 18, 2018

(54) HIGH PRESSURE FUEL PUMP AND FUEL SUPPLY DEVICE FOR AN INTERNAL COMBUSTION ENGINE, IN PARTICULAR OF A MOTOR VEHICLE

(71) Applicant: Continental Automotive GmbH, Hannover (DE)

(72) Inventor: Yavuz KURT, Roding (DE)

(73) Assignee: Continental Automotive GmbH, Hannover (DE)

(21) Appl. No.: 15/766,403

(22) PCT Filed: Sep. 21, 2016
(86) PCT No.: PCT/EP2016/072377

§ 371 Date: Apr. 6, 2018

(30) Foreign Application Priority Data
Oct. 7, 2015 (DE) 10 2015 219 417.5

(51) Int. Cl. F02M 59/02; F02M 59/44; F02M 37/00; F02M 63/02; F02M 69/02; F02M 69/04

(52) U.S. Cl. CPC F02M 59/025; F02M 59/44; F02M 37/0047; F02M 69/046; F02M 63/0285; F02M 69/02; F02M 63/0265

(57) ABSTRACT

The invention relates to a fuel supply device for supplying fuel to a first injection device of an internal combustion engine, in particular of a motor vehicle, having at least one first low-pressure port, via which the fuel can be fed to the high-pressure fuel pump from a low-pressure fuel pump, having at least one second low-pressure port for conducting the fuel conveyed by means of the low-pressure fuel pump and fed to the high-pressure fuel pump away from the high-pressure fuel pump to a second injection device provided in addition to the first injection device, having a pump housing as first structural element, and having a second structural element, which is formed separately from the pump housing and which is held on the pump housing, wherein both low-pressure ports are arranged on one of the structural elements.

### BACKGROUND

The invention relates to a high-pressure fuel pump, as per the preamble patent claim 1, and to a fuel supply device, as per the preamble patent claim 8.

A high-pressure fuel pump of said type, and a fuel supply device of said type for an internal combustion engine, in particular of a motor vehicle, already emerge, so as to be known, for example from US 2012/0312278 A1. The fuel supply device serves for supplying fuel, in particular liquid fuel, to the internal combustion engine. The fuel supply device comprises a first injection device for effecting a direct injection of fuel. This means that the internal combustion engine has at least one combustion chamber into which the fuel can be directly injected by means of the first injection device.

The fuel supply device furthermore comprises a second injection device, which is provided in addition to the first injection device, for effecting an induction pipe injection of fuel. During the course of the induction pipe injection of fuel, which is also referred to as induction pipe injection, the fuel is introduced, in particular injected, into the internal combustion engine at a location arranged upstream of the combustion chamber. Said location is arranged for example in an induction pipe, through which air can flow, of the internal combustion engine, and upstream of an inlet valve of the internal combustion engine.

The fuel supply device furthermore comprises the abovementioned high-pressure fuel pump, by means of which the fuel can be supplied to the first injection device. The fuel supply device furthermore comprises a low-pressure fuel pump for conveying the fuel to the high-pressure fuel pump. By means of the low-pressure fuel pump, the fuel is conveyed for example at a first pressure. In other words, by means of the low-pressure fuel pump, a first pressure of the fuel that is conveyed by means of the low-pressure fuel pump is effected.

By means of the high-pressure fuel pump, the fuel is conveyed for example at a second pressure that is higher than the first pressure. In other words, by means of the high-pressure fuel pump, a second pressure of the fuel that is higher than the first pressure is effected. In this way, it is for example possible for the first injection device to be supplied with the second pressure that is higher than the first pressure, wherein the second injection device can be supplied with the first pressure.

The high-pressure fuel pump has at least one first low-pressure port via which the fuel can be fed to the high-pressure fuel pump from the low-pressure fuel pump. In other words, the fuel conveyed by means of the low-pressure fuel pump is fed via the first low-pressure port to the high-pressure fuel pump.

The high-pressure fuel pump furthermore has at least one second low-pressure port for conducting the fuel conveyed by means of the low-pressure fuel pump away from the high-pressure fuel pump to the second injection device. This means that the fuel conveyed by means of the low-pressure fuel pump is conducted to the high-pressure fuel pump, and in particular fed to the high-pressure fuel pump, via the first low-pressure port, wherein the fuel conveyed by means of the low-pressure fuel pump and fed via the first low-pressure port to the high-pressure fuel pump is conveyed via the second low-pressure port away from the high-pressure fuel pump and in the direction of or to the second injection device.

The high-pressure fuel pump furthermore comprises a pump housing, which is a first structural element of the high-pressure fuel pump. The high-pressure fuel pump furthermore comprises at least one conveying element, which is arranged at least partially in the pump housing and which is movable relative to the pump housing, for conveying the fuel from the high-pressure fuel pump to the first injection device. The conveying element is formed for example as a piston which is movable in translational fashion relative to the pump housing.

Furthermore, the high-pressure fuel pump comprises a cover which is formed separately from the pump housing and which is held on the pump housing and which is a second structural element of the high-pressure fuel pump. For example, a damping device for damping pulsations of the fuel is at least partially arranged in the cover.

Furthermore, WO 2012/004084 A1 discloses a fuel system for an internal combustion engine, having a low-pressure conveying device which conveys at least indirectly to at least one low-pressure injection device. The fuel system furthermore comprises a high-pressure conveying device for the fuel, which high-pressure conveying device has a drive region and a conveying region and conveys at least indirectly to at least one high-pressure injection device. It is provided here that the fuel is conveyed from the low-pressure conveying device firstly into the drive region of the high-pressure conveying device and from there onward to the low-pressure injection device and/or to the conveying region of the high-pressure conveying device.

It is an object of the present invention to further develop a high-pressure fuel pump and a fuel supply device of the type mentioned in the introduction such that the costs of the high-pressure fuel pump or of the fuel supply device as a whole can be kept particularly low.

### BRIEF SUMMARY

Said object is achieved by means of a high-pressure fuel pump having the features of patent claim 1 and also by means of a fuel supply device having the features of patent claim 8. Advantageous embodiments with expedient refinements of the invention are specified in the further claims

To further develop a high-pressure fuel pump of the type specified in the preamble of patent claim 1 such that the costs of the high-pressure fuel pump can be kept particularly low, it is provided according to the invention that both low-pressure ports are arranged on one of the structural elements. In other words, it is provided according to the invention that both low-pressure ports are formed either on the pump housing or else on the second structural element, which is formed for example as a cover. Owing to the arrangement of both low-pressure ports on one structural element, the respective other structural element can be of particularly simple form, in particular with a particular simple geometry, and can thus be produced particularly inexpensively, such that the costs of the high-pressure fuel pump overall can be kept low. Furthermore, the high-pressure fuel pump can be produced and assembled in a particularly simple and time-saving and inexpensive manner.

In an advantageous embodiment of the invention, the low-pressure ports are fluidically connected to one another by means of a connecting region, wherein the connecting region is arranged outside the structural elements. It has been found that, in this way, both structural elements can be produced in a particularly simple and inexpensive manner, such that the costs of the high-pressure fuel pump can be kept low.

A further embodiment is distinguished by the fact that the first low-pressure port and/or the second low-pressure port is formed in one piece with the one structural element. In this way, the number of parts and thus the costs of the high-pressure fuel pump can be kept low.

In a further advantageous embodiment of the invention, the first low-pressure port and/or the second low-pressure port is formed by a component which is formed separately from the one structural element and which is arranged on the one structural element. In this way, the one structural element and the component can be produced inexpensively, wherein, for example, the component can be connected to the one structural element or fastened to the one structural element in a particularly simple and inexpensive manner. It is conceivable here for the component to be fastened cohesively and/or in non-positively locking and/or positively locking fashion to the one structural element.

To keep the number of parts and thus the costs of the high-pressure fuel pump particularly low, it is provided in a further embodiment of the invention that the low-pressure ports are formed in one piece with one another.

It may furthermore be provided that the low-pressure ports are formed by components which are formed separately from one another and which are at least indirectly connected to one another. In this way, said components can be produced particularly inexpensively and connected to one another, such that the high-pressure fuel pump can be produced inexpensively overall.

Finally, it has proven to be advantageous if the low-pressure ports can be flowed through by the fuel along a respective flow direction, wherein the flow directions run parallel or obliquely with respect to one another. In this way, the structural space requirement of the high-pressure fuel pump can be kept small, such that the high-pressure fuel pump can be produced with a low material requirement and thus inexpensively.

To further develop a fuel supply device of the type specified in the preamble of patent claim 8 such that the costs of the fuel supply device can be kept particularly low, it is provided according to the invention that both low-pressure ports are arranged on one of the structural elements. Advantages and advantageous embodiments of the high-pressure fuel pump according to the invention are to be regarded as advantages and advantageous embodiments of the fuel supply device according to the invention, and vice versa.

It has proven to be particularly advantageous here if the high-pressure fuel pump of the fuel supply device according to the invention is a high-pressure fuel pump according to the invention.

The invention also includes a vehicle, in particular a motor vehicle, such as for example a passenger motor vehicle, wherein the vehicle comprises at least one high-pressure fuel pump according to the invention and/or at least one fuel supply device according to the invention. Here, advantages and advantageous embodiments of the high-pressure fuel pump according to the invention and of the fuel supply device are to be regarded as advantageous embodiments of the vehicle according to the invention, and vice versa.

Further advantages, features and details of the invention will emerge from the following description of preferred exemplary embodiments and from the drawing. The features and combinations of features mentioned in the description above and the features and combinations of features mentioned in the description of the figures below and/or shown in the figures alone can be used not only in the respectively stated combination, but also in other combinations or alone without departing from the scope of the invention.

### BRIEF DESCRIPTION OF THE DRAWINGS

In the drawing:

FIG. 1 shows a schematic sectional view of a high-pressure fuel pump according to a first embodiment for supplying fuel to a first injection device of an internal combustion engine, in particular of a motor vehicle, wherein the high-pressure fuel pump has at least two low-pressure ports which are both arranged on one structural element of the high-pressure fuel pump;

FIG. 2 shows a schematic sectional view of the high-pressure fuel pump according to a second embodiment;

FIG. 3 shows a schematic sectional view of the high-pressure fuel pump according to a third embodiment;

FIG. 4 shows a schematic sectional view of the high-pressure fuel pump according to a fourth embodiment; and

FIG. 5 is a schematic illustration of a fuel supply device for an internal combustion engine, wherein the fuel supply device comprises the high-pressure fuel pump according to the first embodiment.

### DETAILED DESCRIPTION

In the figures, identical or functionally identical elements are provided with identical reference signs.

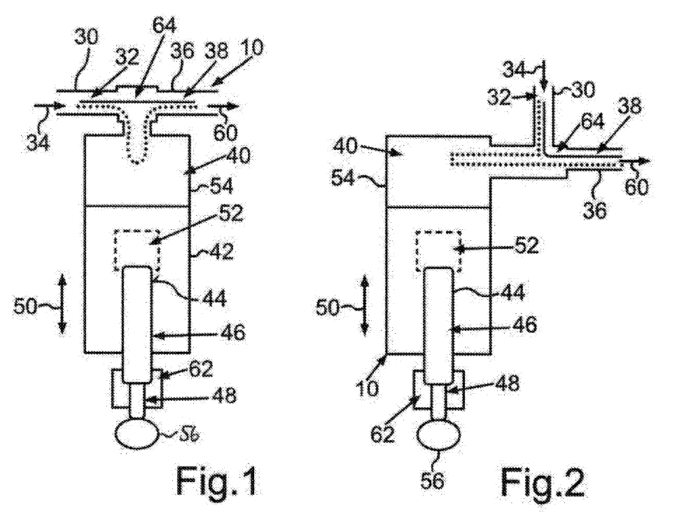

FIG. 1 shows, in a schematic sectional view, a high-pressure fuel pump according to a first embodiment, which is denoted as a whole by 10. Considering said figure together with FIG. 5, it can be seen that the high-pressure fuel pump 10 as a constituent part of a fuel supply device denoted as a whole by 12, by means of which fuel, in particular liquid fuel, can be or is supplied to an internal combustion engine. The fuel may for example be diesel fuel or gasoline. The internal combustion engine serves for example for the drive of a motor vehicle, in particular of a passenger motor vehicle, wherein the internal combustion engine may be formed as a reciprocating-piston internal combustion engine.

The internal combustion engine has a multiplicity of combustion chambers in the form of cylinders, wherein the fuel is fed to the combustion chambers. Furthermore, air is fed to the combustion chambers, such that a fuel-air mixture is formed in the respective combustion chamber from the air and the fuel. The fuel-air mixture is burned, resulting in exhaust gas of the internal combustion engine.

The respective combustion chamber is assigned at least one outlet duct via which the exhaust gas can be discharged from the combustion chamber. The outlet duct is assigned at least one gas exchange valve in the form of an outlet valve, wherein the outlet valve is movable between a closed position and at least one open position. In the closed position, the outlet duct is fluidically shut off by means of the outlet valve, such that the exhaust gas cannot flow from the combustion chamber into the outlet duct. In the open position, the outlet valve opens up the outlet duct, such that the exhaust gas can flow from the combustion chamber into the outlet duct.

Furthermore, the respective combustion chamber is assigned at least one inlet duct, via which the air can be fed to the combustion chamber. Here, the outlet duct is assigned at least one gas exchange valve in the form of an inlet valve, which is adjustable between a closed position and at least one open position. In the closed position, the inlet duct is fluidically shut off by means of the inlet valve, such that the air cannot flow from the inlet duct into the combustion chamber. In the open position, the inlet valve opens up the inlet duct, such that the air can flow through the inlet duct and can flow from the inlet duct into the combustion chamber.

The fuel supply device 12 comprises a first injection device 14, which is formed for example as a high-pressure injection device. Here, each combustion chamber is assigned an injection valve 16 of the first injection device 14. The first injection device 14 is in this case designed for effecting a direct injection of fuel, wherein the direct injection of fuel is also referred to as direct injection. During the course of the direct injection, the fuel is injected by means of the respective injection valve 16 directly into the respective combustion chamber, in particular cylinder. Here, the first injection device 14 comprises a fuel distribution element 18 which is common to the injection valves 16 and via which the fuel can be supplied to the injection valves 16. The fuel distribution element 18 is also referred to as rail, wherein the fuel distribution element 18 is referred to as high-pressure rail if the first injection device 14 is formed as a high-pressure injection device. By means of the first injection device 14, the fuel is injected for example at a first pressure into the combustion chambers, wherein, for example, the fuel at said first pressure can be accommodated in the fuel distribution element 18 and fed at the first pressure to the injection valves 16.

The fuel supply device 12 furthermore comprises a second injection device 20 which is provided in addition to the first injection device 14 and which is formed for example as a low-pressure injection device. The second injection device 20 is in this case designed for effecting an induction pipe injection of fuel, wherein the induction pipe injection of fuel is also referred to as induction pipe injection. Here, each combustion chamber is assigned at least one injection valve 22 of the second injection device 20.

The air is fed to the combustion chambers for example via an intake tract of the internal combustion engine, such that the intake tract can be flowed through by the air. The intake tract comprises for example an induction pipe, which is also referred to as induction module, intake module or a distributor. The intake tract may furthermore comprise the inlet ducts.

In the case of the induction pipe injection, the fuel is introduced, in particular injected, into the internal combustion engine, in particular into the intake tract, by means of the respective injection valve 22 at a location arranged upstream of the respective combustion chamber. In other words, the location at which the fuel is injected by means of the respective injection valve 22 is arranged upstream of the combustion chamber and in particular in the intake tract. Said location may be arranged for example in the induction pipe or in the inlet duct. In particular, the respective location at which the fuel can be injected by means of the respective injection valve 22 is arranged upstream of the respective inlet valve.

The second injection device 20 also comprises a fuel distribution element 24 which is common to the injection valves 22 and via which the fuel can be supplied to the injection valves 22. Here, the fuel distribution element 24 is also referred to as rail. Since the second injection device 20 is formed for example as a low-pressure injection device, the fuel distribution element 24 is also referred to as low-pressure rail. By means of the second injection device 20, the fuel can be injected for example at a second pressure that is lower than the first pressure. Here, the fuel at the second pressure may for example be accommodated or stored in the fuel distribution element 24 and fed at the second pressure to the injection valves 22. The fuel supply device 12 furthermore comprises a tank 26 in which the in particular liquid fuel can be accommodated.

It can be seen from FIG. 5 that the high-pressure fuel pump 10 serves for the supply of the fuel to the first injection device 14. In other words, the fuel is supplied to the first injection device 14 by means of the high-pressure fuel pump 10, wherein the fuel is compressed or pressurized for example by means of the high-pressure fuel pump 10 such that the stated first pressure of the fuel can be or is effected for example by means of the high-pressure fuel pump 10. In other words, the fuel is conveyed at the first pressure to the first injection device 14 by means of the high-pressure fuel pump 10.

The fuel supply device 12 furthermore comprises a low-pressure fuel pump 28 which is provided in addition to the high-pressure fuel pump 10 and which serves for conveying the fuel from the tank 26 to the high-pressure fuel pump 10. In other words, the fuel is conveyed from the tank 26 to the high-pressure fuel pump 10 by means of the low-pressure fuel pump 28. For example, the fuel is conveyed at a third pressure by means of the low-pressure fuel pump 28. This means that a third pressure of the fuel is effected for example by means of the low-pressure fuel pump 28, wherein the fuel is conveyed at the third pressure to the high-pressure fuel pump 10 by means of the low-pressure fuel pump 28. Here, the third pressure may correspond to the second pressure, such that, for example, the second pressure of the fuel can be effected by means of the low-pressure pump. In other words, the low-pressure fuel pump 28 can for example convey the fuel at the second pressure.

It can be seen from FIGS. 1 and 5 that the high-pressure fuel pump 10 has a first low-pressure port 30 which comprises a first duct 32 which can be flowed through by the fuel. Via the first low-pressure port 30, the high-pressure fuel pump 10 is fluidically connected to the low-pressure fuel pump 28, such that the fuel conveyed by means of the low-pressure fuel pump 28 can be or is fed, in particular at the second or third pressure, from the low-pressure fuel pump 28 to the high-pressure fuel pump 10 via the first low-pressure port 30, in particular via the first duct 32. This feed is illustrated in FIG. 1 by means of a directional arrow 34. Since the fuel is fed via the first low-pressure port 30 or via the first duct 32 to the high-pressure fuel pump 10, the first low-pressure port 30 is also referred to as inflow.

The high-pressure fuel pump 10 furthermore comprises at least one second low-pressure port 36, which has a second duct 38 which can be flowed through by the fuel. The second low-pressure port 36 or the second duct 38 serves for conducting the fuel conveyed by means of the low-pressure fuel pump 38 and fed to the high-pressure fuel pump 10 via the inflow (first low-pressure port 30), in particular at the second or third pressure, away from the high-pressure fuel pump to the second injection device 20, in particular to the fuel distribution element 24, such that the fuel can be accommodated or stored at the second or third pressure in the fuel distribution element 24.

It can be seen from FIG. 5 that the second injection device 20, in particular the fuel distribution element 24, is fluidically connected to the high-pressure fuel pump 10 via the second low-pressure port 36, such that the fuel that is initially fed to the high-pressure fuel pump 10 via the inflow can be fed or is fed via the second low-pressure port 36 to the fuel distribution element 24. Thus, the fuel at the third pressure or second pressure flows through the first low-pressure port 30 or the first duct 32. In other words, the fuel in the first low-pressure port or in the first duct 32 is for example at the third pressure effected by means of the low-pressure fuel pump 38, which may correspond to the second pressure. Furthermore, the fuel at the second pressure flows through the second low-pressure port 36 or the second duct 38. In other words, the fuel in the second low-pressure port 36 or in the second duct 38 is at the second pressure.

The high-pressure fuel pump 10 has a low-pressure chamber 40 which can be flowed through by at least a part of the fuel fed to the high-pressure fuel pump 10 via the inflow (first low-pressure port 30).

The high-pressure fuel pump 10 furthermore comprises a first structural element in the form of a pump housing 42. Furthermore, the high-pressure fuel pump 10 comprises a conveying element for conveying at least a part of the fuel fed to the high-pressure fuel pump 10 via the inflow, wherein said conveying element is in the present case formed as a piston 44. The piston 44 is also referred to as conveying piston, wherein the piston 44 in the present case has a first length region 46 and an adjoining second length region 48. The length region 46 has a first outer circumference, wherein the length region 48 has a second outer circumference which is shorter than the first outer circumference. The length regions 46 and 48 are preferably formed in one piece with one another. Since the length regions have different outer circumferences, the piston 44 has a step. The piston 44 is thus formed as a stepped pin.

It is alternatively also conceivable for the length regions 46 and 48 to have the same outer circumference, such that the piston 44 has no step.

The piston 44 is arranged at least partially in the pump housing 42, and in this case is movable relative to the pump housing 42, wherein the piston 44 is in the present case movable in translational fashion relative to the pump housing 42. Said translational mobility of the piston 44 relative to the pump housing 42 is indicated in FIG. 1 by a double arrow 50. On a first side of the piston 44, a compression chamber 52, illustrated in particularly schematic form in FIG. 1, of the high-pressure pump 10 is depicted, wherein the compression chamber 52 is arranged for example in the pump housing 42. A volume of the compression chamber 52 can be varied by translational movement of the piston 44 relative to the pump housing 42 and thus relative to the compression chamber 52.

The high-pressure fuel pump 10 furthermore comprises a second structural element in the form of a cover 54, which is formed separately from the pump housing 42 and which is connected to the pump housing 42 or held on the pump housing 42.

Furthermore, a drive element is provided in the form of a cam 56 which is illustrated particularly schematically in FIG. 1 and by means of which the piston 44 is movable relative to the pump housing 42, in the present case in the direction of the cover 54. Here, the high-pressure fuel pump 10 comprises at least one spring element which is not illustrated in FIG. 1 and which is placed under stress by movement of the piston 44 in the direction of the cover 54. By means of the spring element, the piston 44 is moved from the cover 54 back in the direction of the cam 56 and is in particular held in supported contact with the cam 56 by relaxation of the spring element. Movement of the piston 44 in the direction of the cover 54 causes the volume of the compression chamber 52 to be decreased, whereby the fuel accommodated in the compression chamber 52 is compressed, that is to say pressurized.

Movement of the piston 44 away from the cover 54 causes the volume of the compression chamber 52 to be increased, whereby fuel is drawn into the compression chamber 52. Here, it is provided in particular that the compression chamber 52 is fluidically connectable or connected to the low-pressure chamber 40, such that fuel can be or is drawn into the compression chamber 52 from the low-pressure chamber 40 by means of the piston 44.

The fuel that is drawn and thus flows from the low-pressure chamber 40 into the compression chamber 52 is at least a part of the fuel fed via the inflow to the high-pressure fuel pump 10, because at least a part of the fuel fed by the inflow to the high-pressure fuel pump 10 can flow into the low-pressure chamber 40 and be drawn from there into the compression chamber 52 by means of the piston 44.

As a result of the compression of the fuel, a fourth pressure of the fuel can be effected or set by means of the high-pressure fuel pump 10, wherein the fourth pressure is higher than the second and the third pressure. For example, the fourth pressure corresponds to the first pressure, such that the first injection device 14, in particular the fuel distribution element 18, can be supplied with the first pressure or force pressure by means of the high-pressure fuel pump 10.

It can be seen from FIG. 5 that the high-pressure fuel pump 10 comprises a high-pressure port 58 (not illustrated in FIG. 1) via which fuel compressed or pressurized by means of the piston 44 can be fed from the compression chamber 52 to the first injection device 14, in particular to the fuel distribution element 18. This means that the first injection device 14, in particular the fuel distribution element 18, is fluidically connected to the high-pressure fuel pump 10 via the high-pressure port 58. Here, the fuel flows through the high-pressure port 58 at the fourth pressure. In other words, the fuel in the high-pressure port 58 is at the fourth pressure, which is significantly higher than the second and the third pressure.

FIG. 1 shows a solid line which is used to illustrate a possible first flow of at least a part of the fuel flowing through the duct 32, and thus through the first low-pressure port 30, from the first low-pressure port 30 to the second low-pressure port 36. During the course of this first flow, the fuel flow is at least substantially directly from the first low-pressure port 30 to the second low-pressure port 36 and through the latter, or through the second duct 38. Here, said first flow circumvents the pump housing 42 and the low-pressure chamber 40. In other words, the first flow does not flow through the low-pressure chamber 40 and the pump housing 42.

Furthermore, FIG. 1 shows a dotted line which is used to illustrate a possible second flow of at least a part of the fuel flowing through the duct 32, and thus through the first low-pressure port 30, from the first low-pressure port 30 to the second low-pressure port 36. Here, the second flow is provided as an alternative to the first flow. The second flow flows from the first low-pressure port 30 or from the duct 32 initially into the low-pressure chamber 40 and through the latter. Then, the second flow runs from the low-pressure chamber 40 to the second low-pressure port 36. The second flow therefore does not circumvent the low-pressure chamber 40 but can circumvent the pump housing 42.

Both the first flow and the second flow can flow, or be conducted, via the second low-pressure port 36 away from the high-pressure fuel pump 10 to the second injection device 20. The first flow thus runs substantially directly from the first low-pressure port 30 to the second low-pressure port 36, circumventing the low-pressure chamber 40, wherein the second flow runs from the first low-pressure port 30 to the second low-pressure port 36 via the second low-pressure chamber 40. The flow of the fuel through the second low-pressure port 36 to the second injection device 20 is illustrated in FIG. 1 by a directional arrow 60.

Since each combustion chamber is assigned an injection valve 22 of the second injection device 20, multiple locations arranged upstream of the combustion chambers are provided at which fuel is injected by means of the second injection device 20. This type of induction pipe injection is also referred to as multi-port injection (MPI), such that the second low-pressure port 36 is also referred to as MPI port.

Here, it is for example possible for at least one of the injection devices 14 and 20, in particular the first injection device 14, to be activated and de-activated according to demand. In the activated state of the injection device 14, the fuel is injected by means of the injection device 14 directly into the combustion chambers. In the deactivated state of the injection device 14, a direct injection of the fuel into the combustion chambers effected by means of the injection device 14 is omitted. Here, even in the deactivated state of the injection device 14, the fuel that is at the third pressure or second pressure, which is lower than the fourth pressure or first pressure, is fed to the high-pressure fuel pump 10 via the inflow. Since the fuel flowing through the inflow is not compressed by means of the high-pressure fuel pump 10 or has not yet been compressed by means of the high-pressure fuel pump 10, the fuel flowing through the inflow is at a low temperature, such that the high-pressure fuel pump 10 is for example cooled by means of the fuel fed to the high-pressure fuel pump 10 via the inflow even when the injection device 14 is deactivated. For this purpose, the fuel flow through the high-pressure fuel pump 10, whereby the latter is cooled.

On a side of the piston 44 averted from the compression chamber 52, a chamber 62 is provided which functions for example as a collecting chamber. The piston 44 is guided for example by means of a guide that is not shown in FIG. 1. Owing to leakages, fuel can flow out of the compression chamber 52 between the piston and the guide, wherein said fuel is also referred to as leakage fuel. The leakage fuel flows into the chamber 62 and is thus collected by means of the chamber 62. It is preferably provided here that the chamber 62 is fluidically connected to the low-pressure chamber 40 by means of at least one connecting duct. The chamber 62 has a volume which is variable by movement of the piston 44 relative to the pump housing 42. If the piston 44 is moved away from the cover 54 in particular by means of the spring element, whereby the volume of the compression chamber 52 is increased, the volume of the chamber 62 is decreased as a result. As a result, for example, fuel that is accommodated in the chamber 62 is conveyed out of the chamber 62 and is conveyed in particular via the stated fluidic connection into the low-pressure chamber 40.

If the piston 44 is moved in the direction of the cover 54 in particular by means of the cam 56, whereby the volume of the compression chamber 52 is decreased, the volume of the chamber 62 is increased. As a result, for example, fuel is drawn from the low-pressure chamber 40 into the chamber 62 via the stated fluidic connection. As already described above, at least a part of the fuel fed to the high-pressure fuel pump 10 via the inflow can flow into the low-pressure chamber 40, because the in-flow, in particular the first duct 32, is fluidically connected to the low-pressure chamber 40.

Fuel is thus conveyed back and forth between the chamber 62 and the low-pressure chamber 40 by movement of the piston 44.

As a result of fuel being drawn into the compression chamber 52 and/or into the chamber 62 and the fuel being conveyed out of the compression chamber 52 and/or out of the chamber 62, pulsations of the fuel can arise. It is conceivable here for a damping device to be arranged at least partially in the cover 54, by means of which damping device the stated pulsations of the fuel can be dampened. The cover 54 is thus for example also referred to as damper cover.

It is self-evidently also conceivable for the inflow and the MPI port to be interchanged, such that for example the low-pressure port 36 is formed as inflow and the low-pressure port 30 is formed as MPI port, such that then, for example, the flow direction of the fuel illustrated by the directional arrows 34 and 60 is reversed.

To now be able to keep the costs of the high-pressure fuel pump 10 and thus of the fuel supply device 12 particularly low overall, both low-pressure ports 30 and 36 are arranged on one of the structural elements. It can be seen from FIG. 1 that, in the first embodiment, it is provided that both low-pressure ports 30 and 36 are arranged on the cover 54. This means that both low-pressure elements 30 and 36 are held on the same structural element, in particular directly. Here, the low-pressure ports 30 and 36, in particular the ducts 32 and 38, are fluidically connected to one another by means of a connecting region 64 which is arranged outside the structural elements, that is to say outside the pump housing 42 and outside the cover 54. Via the connecting region 64, the fuel can flow directly from the duct 32 into the duct 38.

The connecting region 64 is arranged for example outside the structural elements in order to realize the above-described first flow. The fuel or the first flow can thus flow substantially directly from the first low-pressure port 30 to the second low-pressure port 36 through the connecting region 64.

It is furthermore conceivable for the connecting region 64 to be arranged within one of the structural elements. For example, the connecting region 64 is arranged in the cover 54, in particular in the low-pressure chamber 40, in order to thereby realize the second flow through the second low-pressure chamber 40.

It is possible for the first low-pressure port 30 to be formed in one piece with the cover 54. It is alternatively or additionally possible for the second low-pressure port 36 to be formed in one piece with the cover 54. It is furthermore possible for the first low-pressure port 30 to be formed by a component which is formed separately from the cover 54 and which is arranged, in particular held, on the cover 54. It is alternatively or additionally possible for the second low-pressure port 36 to be formed by a component which is formed separately from the cover 54 and which is arranged, in particular held, on the cover 54. It is furthermore possible for the low-pressure ports 30 and 36 to be formed in one piece with one another. It is furthermore conceivable for the low-pressure ports 30 and 36 to be formed by components which are formed separately from one another and which are at least indirectly, in particular directly, connected to one another.

The low-pressure port 30 can be flowed through by the fuel along a flow direction illustrated by the directional arrow 34. Furthermore, the low-pressure port 36 can be flowed through by the fuel along a second flow direction illustrated by the directional arrow 60, wherein the flow directions may run obliquely with respect to one another. In the first embodiment, it is provided that the flow direction is run at least substantially parallel to one another.

FIG. 2 shows a second embodiment of the high-pressure fuel pump 10. The second embodiment differs from the first embodiment in particular in that the stated flow directions, illustrated by means of the directional arrows 34 and 60, run perpendicular to one another or enclose an angle of at least substantially 90°. It is also conceivable here for the inflow and the MPI port to be interchanged.

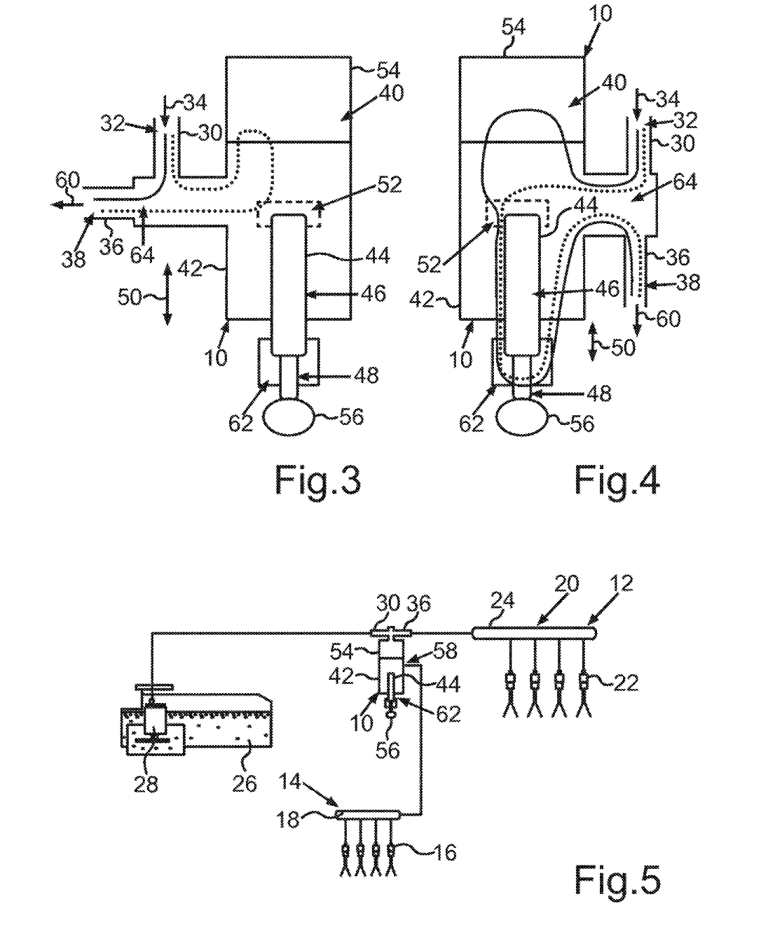

FIG. 3 shows a third embodiment of the high-pressure fuel pump 10. In the third embodiment, the flow directions illustrated by means of the directional arrows 34 and 60 run at an angle, and in the present case perpendicularly, with respect to one another. The third embodiment differs from the first and second embodiments in particular in that both low-pressure ports 30 and 36 are arranged on the pump housing 42.

Finally, FIG. 4 shows a fourth embodiment of the high-pressure fuel pump 10. It is also the case in the fourth embodiment that both low-pressure ports 30 and 36 are arranged on the pump housing 42. The fourth embodiment differs from the third embodiment in particular in that the flow directions illustrated by means of the directional arrows 34 and 60 run at least substantially parallel to one another. By contrast to FIGS. 1 to 3, the dotted line in FIG. 4 illustrates the first flow which flows from the low-pressure port 30 to the low-pressure port 36 and which flows through the duct 38 and in so doing circumvents the low-pressure chamber 40, wherein the solid line in FIG. 4 illustrates the above-described second flow which, by contrast to the first flow, does not circumvent the low-pressure chamber 40 but rather flows through the low-pressure chamber 40.

Furthermore, it is provided in the first embodiment, in the second embodiment and in the third embodiment that the fuel flows from the in-flow, in particular from the first duct 32, to the MPI port, in particular to the second duct 38, circumventing the chamber 62. In other words, the fuel flows from the duct 32 to the duct 38, and in so doing circumvents the chamber 62. This is to be understood to mean that the fuel flowing through the duct 38 does not flow through the chamber 62.

By contrast, in the fourth embodiment, the fuel flowing through the duct 38 flows firstly through the first duct 32, subsequently through the chamber 62 and subsequently through the second duct 38, such that the fuel flows firstly through the chamber 62 and thereafter, or subsequently, through the second duct 38. This means that the fuel flowing from the duct 32 to the duct 38 does not circumvent the chamber 62.

By contrast to the flows of the fuel through the chamber 62 as shown in FIG. 4, it may be provided that the fuel flowing from the low-pressure port 30 to the low-pressure port 36 and flowing through the duct 38 circumvents the chamber 62, that is to say does not flow through the chamber 62. A flow of the fuel as in the first, second and third embodiments may thus also be provided in the fourth embodiment.

1. A high-pressure fuel pump for supplying fuel to a first injection device of an internal combustion engine, in particular of a motor vehicle, having at least one first low-pressure port, via which the fuel can be fed to the high-pressure fuel pump from a low-pressure fuel pump, having at least one second low-pressure port for conducting the fuel conveyed by means of the low-pressure fuel pump and fed to the high-pressure fuel pump away from the high-pressure fuel pump to a second injection device provided in addition to the first injection device, having a pump housing as first structural element, in which there is arranged at least one conveying element which is movable relative to the pump housing and which serves for conveying the fuel to the first injection device, and having at least one second structural element, which is formed separately from the pump housing and which is held on the pump housing,
characterized in that
both low-pressure ports are arranged on one of the structural elements.

2. The high-pressure fuel pump as claimed in claim 1,
characterized in that
the low-pressure ports are fluidically connected to one another by means of a connecting region which is arranged outside the structural elements.

3. The high-pressure fuel pump as claimed in claim 1,
characterized in that
the first low-pressure port and/or the second low-pressure port is formed in one piece with one structural element.

4. The high-pressure fuel pump as claimed in claim 3,
characterized in that
the first low-pressure port and/or the second low-pressure port is formed by a component which is formed separately from one structural element and which is arranged on said one structural element.

5. The high-pressure fuel pump as claimed in claim 4,
characterized in that
the low-pressure ports are formed in one piece with one another.

6. The high-pressure fuel pump as claimed in claim 5,
characterized in that
the low-pressure ports are formed by components which are formed separately from one another and which are at least indirectly connected to one another.

7. The high-pressure fuel pump as claimed in claim 6,
characterized in that
the low-pressure ports can be flowed through by the fuel along a respective flow direction, wherein the flow directions run parallel to or obliquely with respect to one another.

8. A fuel supply device for supplying fuel to an internal combustion engine, in particular of a motor vehicle, having a first injection device for effecting a direct injection of fuel, having a second injection device which is provided in addition to the first injection device and which serves for effecting an induction pipe injection of fuel, having a high-pressure fuel pump for supplying the fuel to the first injection device and having a low-pressure fuel pump for conveying the fuel to the high-pressure fuel pump, which fuel supply device comprises at least one first low-pressure port, via which the fuel can be fed to the high-pressure fuel pump from the low-pressure fuel pump, at least one second low-pressure port, for conducting the fuel conveyed by means of the low-pressure fuel pump and fed to the high-pressure fuel pump away from the high-pressure fuel pump to the second injection device, a pump housing as first structural element, at least one conveying element which is arranged at least partially in the pump housing and which is movable relative to the pump housing and which serves for conveying the fuel to the first injection device, and at least one second structure element, which is formed separately from the pump housing and which is held on the pump housing,
characterized in that
both low-pressure ports are arranged on one of the structural elements.

9. The fuel supply device as claimed in claim 8, characterized in that
the high-pressure fuel pump high-pressure fuel pump for supplying fuel to the first injection device of the internal combustion engine,
characterized in that
the low-pressure ports are fluidically connected to one another by means of a connecting region which is arranged outside the structural elements,
the first low-pressure port and/or the second low-pressure port is formed in one piece with one structural element,
the first low-pressure port and/or the second low-pressure port is formed by a component which is formed separately from one structural element and which is arranged on said one structural element,
the low-pressure ports are formed in one piece with one another,
the low-pressure ports are formed by components which are formed separately from one another and which are at least indirectly connected to one another, and
the low-pressure ports can be flowed through by the fuel along a respective flow direction, wherein the flow directions run parallel to or obliquely with respect to one another.

10. (canceled)
